(19) United States
(12) Patent Application Publication
(10) Pub. No.: US 2007/0126246 A1
(43) Pub. Date: Jun. 7, 2007

(54) Vehicle door opening/closing device

(75) Inventors: Shintaro Suzuki, Kasugai-shi (JP); Hiroshi Ishihara, Anjo-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/600,088

(22) Filed: Nov. 16, 2006

(30) Foreign Application Priority Data
Nov. 18, 2005 (JP) 2005-334299

(51) Int. Cl. E05B 3/00

(52) U.S. Cl. 292/336.3

(57) ABSTRACT

A vehicle door opening/closing device includes a door handle provided at the exterior of a vehicle door and by which the vehicle door is opened and closed, control device executing a vehicle door opening process for the vehicle door on the basis of a user's door handle operation to open the vehicle door, input device provided at the door handle and inputting the user's door handle operation to open the vehicle door, wherein on the basis of the user's door handle operation to open the vehicle door, the control device executes the vehicle door opening process for one of vehicle doors, to which the door handle is not provided.

### CROSS REFERENCE TO RELATED APPLICATIONS

This application is based on and claims priority under 35 U.S.C. § 119 to Japanese Patent Application 2005-334299, filed on Nov. 18, 2005, the entire content of which is incorporated herein by reference.

### FIELD OF THE INVENTION

The present invention relates to a vehicle door opening/closing device. Specifically, on the basis of a user's door handle operation to open the vehicle door at the door handle, which is provided at the exterior of the vehicle, the vehicle door opening process is executed by a control means.

### BACKGROUND

According to a known vehicle door opening/closing device disclosed in, for example JP07076220A, an operating switch for opening and closing vehicle doors is provided at the exterior of the vehicle on each of vehicle doors and controlled from the driver's seat side and the passenger's seat side. By means of this vehicle door opening/closing device, the user can operate a selected vehicle door to be opened and closed. Specifically, the user can operate the selected vehicle door to be opened and closed by operating a switch of a remote controller provided independently from the vehicle door.

According to the known vehicle door opening/closing device, when a user, approaching a vehicle door at the driver's seat side, intends to open one of the other doors such as a door at the passenger seat side, the user can operate the one of the other doors by operating the remote controller, however, if the user stores the remote controller in his/her pocket or bag, and it takes some time for the user to take out the remote controller from the pocket or bag, the vehicle door cannot be opened smoothly. In this situation, the user needs to move to the side of the other doors and operate the operation switch provided at the other door in order to open the other doors.

A need thus exists to provide a vehicle door opening/closing device by which, when the user operates a certain member provided at one door, selected other doors can be opened.

### SUMMARY OF THE INVENTION

According to an aspect of the present invention, 1. A vehicle door opening/closing device includes a door handle provided at the exterior of a vehicle door and by which the vehicle door is opened and closed, control means executing a vehicle door opening process for the vehicle door on the basis of a user's door handle operation to open the vehicle door, input means provided at the door handle and inputting the user's door handle operation to open the vehicle door, wherein on the basis of the user's door handle operation to open the vehicle door, the control means executes the vehicle door opening process for one of vehicle doors, to which the door handle is not provided.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a diagram indicating an example of a vehicle door opening/closing device according to the embodiment of the present invention;

FIG. 2 illustrates an oblique perspective indicating a vehicle door;

FIG. 3 illustrates a top view of the vehicle to which the vehicle door opening/closing device according to the embodiment of the present invention is applied;

FIG. 4 illustrates a flow chart indicating a vehicle door unlocking process and a vehicle door opening process;

FIG. 5A and FIG. 5B illustrate a flow chart indicating a description of the vehicle door opening process; and

FIG. 6 illustrates a flow chart indicating a vehicle door locking process.

### DETAILED DESCRIPTION

An embodiment in which a smart entry system related to the present invention is applied will be explained in accordance with the attached drawings.

(System Configuration)

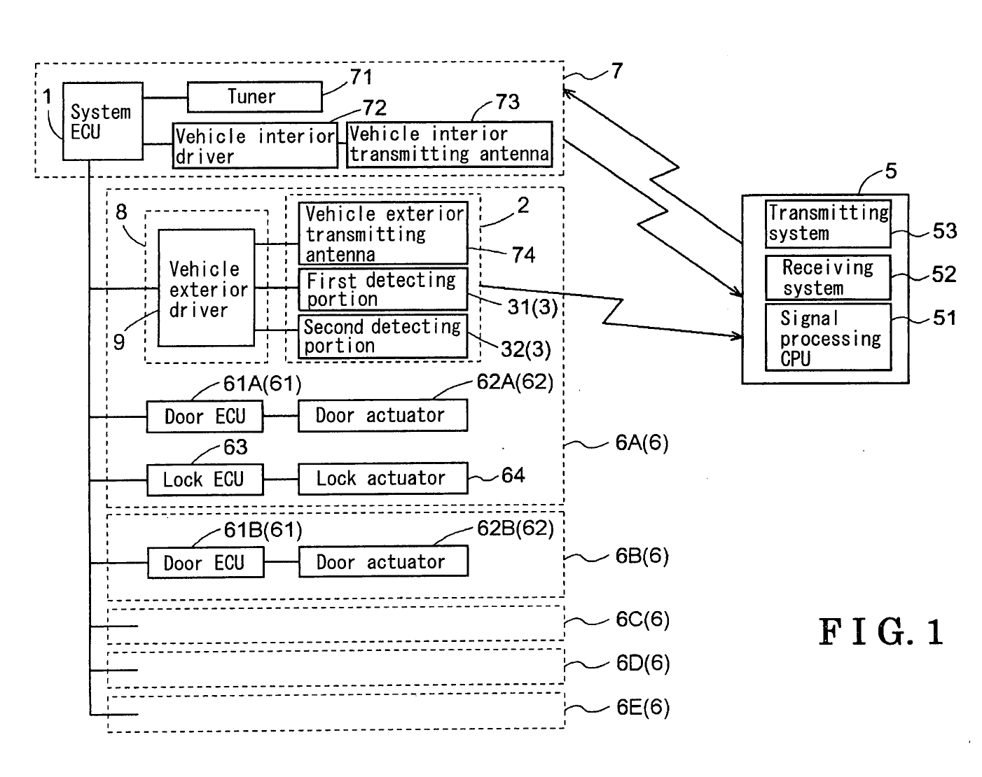

FIG. 1 illustrates an example of a system configuration related to the embodiment of the present invention. A configuration of the smart entry system will be explained in accordance to FIG. 1. After it is detected that a user (driver), possessing a portable device 5, approaches the vehicle, or it is detected that the user gets out of the vehicle, the smart entry system controls the vehicle door 6 to be unlocked, opened or locked automatically. For example, when the user possessing the portable device 5 approaches the vehicle, the smart entry system at the vehicle side recognizes the approaching user. Then, when the user touches a door handle 2, the smart entry system receives a user's door handle operation to unlock the vehicle door and controls the vehicle door 6 to be automatically unlocked.

As shown in FIG. 1, the portable device 5 possessed by the user includes a receiving system 52, a transmitting system 53 and a signal processing CPU 51. Specifically, the receiving system 52 is formed of, for example, an antenna and a tuner for receiving an electric wave from the vehicle, the transmitting system 53 is formed of an antenna and a modulation circuit for transmitting an electric wave to the vehicle, and the signal processing CPU 51 executes a signal processing such as a control to transmit and receive the signal, determining the received signal, generating the transmitted signal and the like.

Within the vehicle interior 7, a system ECU (Electronic Control Unit) 1, a tuner 71, a vehicle interior transmitting antenna 73, and a vehicle interior driver 72 are provided. Specifically, the system ECU (Electronic Control Unit) 1 serving as a control means totally controls the smart entry system, the tuner 71 receives the transmitted signal transmitted from the portable device 5, the vehicle interior transmitting antenna 73 transmits the signal to the portable device 5, and the vehicle interior driver 72 executes a signal processing such as a modulation and an amplification for the signal transmitted by means of the vehicle interior transmitting antenna 73. The system ECU 1 further includes a recognizing means for recognizing the portable device 5 approaching the vehicle or the portable device 5 moving outside of the vehicle.

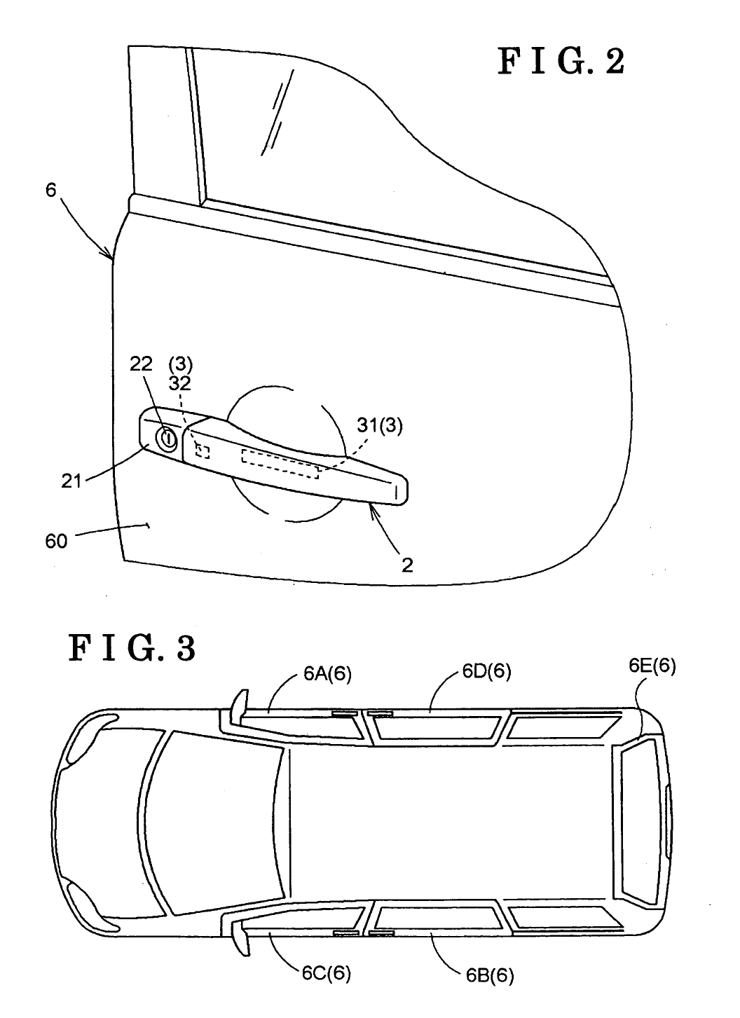

As shown in FIG. 1 and FIG. 2, a door handle 2 serving as an operating portion, by which the vehicle door 6 is opened and closed, is provided at a door panel 60 of the vehicle door 6. The door handle 2 includes a vehicle exterior transmitting antenna 74 for transmitting the signal to the portable device 5 and an input means 3 for inputting the user's door handle operation. At the inside of a handle frame 8 by which the door handle 2 is supported at the vehicle door 6, a vehicle exterior driver 9 for transmitting and receiving a signal relative to each portion of the door handle 2 is provided. Further, at the inside of the door panel 60 of each vehicle door 6, a door actuator 62, a door ECU 61, a lock actuator 64 and a lock ECU 63 are provided. Specifically, the door actuator 62 actuates the vehicle door 6 so as to be opened and closed, the door ECU 61 controls the door actuator 62, the lock actuator 64 actuates a lock mechanism provided at the vehicle door 6 so as to be locked and unlocked, and the lock ECU 63 controls the lock actuator 64. The door ECU 61, the lock ECU 63 and the vehicle exterior driver 9 are controlled by the system ECU 1.

In this embodiment, the input means 3 provided at the door handle 2 includes a first detecting portion 31 detecting a user's door handle operation to unlock the vehicle door and a second detecting portion 32 detecting a user's door handle operation to lock the vehicle door. As described later, the first detecting portion 31 and the second detecting portion 32 cooperate to detect a user's door handle operation to open the vehicle door.

(Configuration of Each Part)

The door handle 2 is supported at exterior of the door panel 60 as shown in FIG. 2. A handle cap 21 is attached to a rear end portion in a vehicle front-rear direction of the door handle 2. The handle cap 21 includes a key cylinder 22, which is used when the user manually locks and unlocks the vehicle door 6 by using a key. The vehicle exterior driver 9 is provided inside of the handle frame 8, and the vehicle exterior driver 9 is connected to the system ECU 1 provided within the vehicle interior 7 and each portion provided inside the door handle 2 by means of a wire harness (not shown).

As shown in FIG. 1, a vehicle exterior transmitting antenna 74 and an input means 3 are provided inside the door handle 2. In this embodiment, the vehicle exterior transmitting antenna 74 is composed of a loop antenna using a ferrite or the like, however, another type of antenna may be used for the vehicle exterior transmitting antenna 74 depending on a required frequency band.

As shown in FIG. 2, on an outer surface of the door handle 2, which does not face the door panel 60, the second detecting portion 32 is provided, and on an inner surface of the door handle 2, which faces the door panel 60, the first detecting portion 31 is provided. In this configuration, when the user intends to open the vehicle door 6 manually, the user pulls the door handle 2 by his/her hand. At this point, the first detecting portion 31 provided on the inner surface of the door handle 2 detects that the user's hand contacts the door handle. On the other hand, after the user gets out of the vehicle and closes the vehicle door 6, when the user presses or touches the second detecting portion 32 provided at outer surface of the door handle 2 by his/her finger or the like, the second detecting portion 32 detects the user's door handle operation to lock the vehicle door. Further, when the user intends to open the other vehicle door 6, at which the door handle 2 is not provided; because the user grips the door handle 2 of the vehicle door 6, the first detecting portion 31 provided at the inner surface of the door handle 2 detects the user's hand contacting the door handle 2. In this configuration, when the user touches or presses the second detecting portion 32 by using his/her gripping hand's thumb, the second detecting portion 32 detects a user's door handle operation to open the vehicle door. In this configuration, the vehicle door 6 is opened depending on the types of the user's door handle operation detected by the second detecting portion 32.

The second detecting portion 32 may be provided in the vicinity of the rear end portion of the door handle 2. In this configuration, because the second detecting portion 32 is located at a place where, while the user grips the door handle 2, his/her thumb can reach the second detecting portion 32; the user's door handle operation to open the vehicle door can easily be detected by the second detecting portion 32. Further, the second detecting portion 32 is located at the abovementioned position, it can be prevented that the user accidentally touches the second detecting portion 32 regardless of the user's intention to open the vehicle door 6, and further it can prevent the other vehicle door from opening unexpectedly.

In this embodiment, an electrostatic capacitance sensor is used as the first detecting portion 31 and the second detecting portion 32, serving as the input means; however, another configuration can be applied to the input means. For example, as long as the input means including the first detecting portion 31 and the second detecting portion 32 detects a human touching the switch, another configuration such as a mechanical switch may be used as the input means. In this case, assigning a number of operating times to each vehicle door for a vehicle door to be opened can be specified depending on the number of operating times of the mechanical switch.

(Unlocking Process)

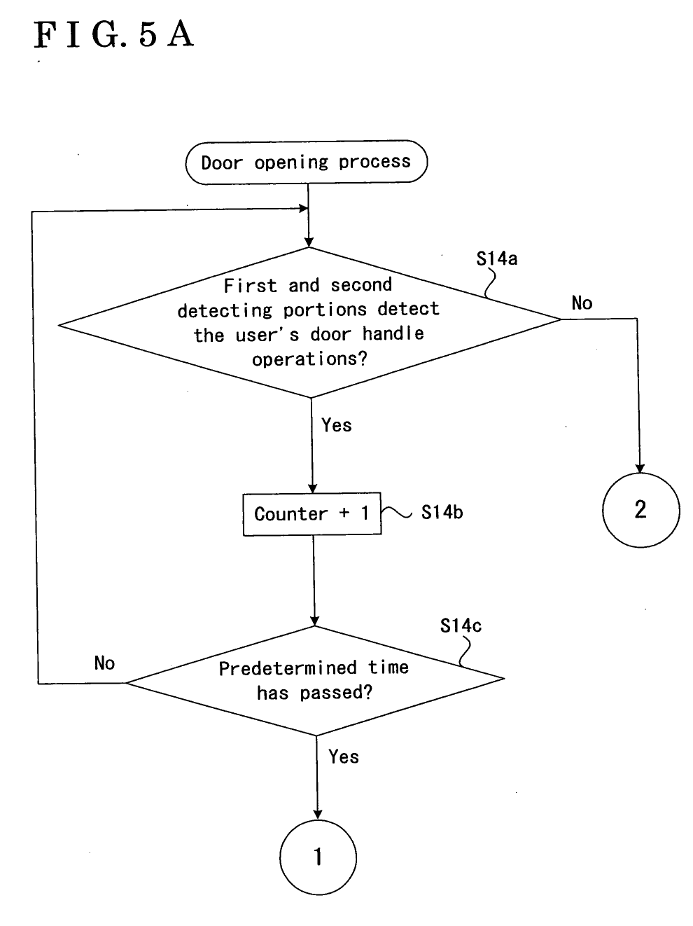

Actuation flows in the above mentioned configuration for controlling to unlock, open and lock the vehicle door will be explained. FIG. 4 illustrates a flow chart indicating a vehicle door unlocking process and a vehicle door opening process according to the embodiment of the present invention. While the vehicle is parked, the vehicle exterior driver 9 outputs a request signal in order to recognize the portable device 5, serving as an electric key that is registered for the vehicle. A transmitting amplifier provided within the vehicle exterior driver 9 modulates and amplifies the request signal and outputs an electric wave from the vehicle exterior transmitting antenna 74 provided at the door handle 2 toward the exterior of the vehicle. This electric wave is received at the receiving system 52 of the portable device 5. Then, the portable device 5 executes a signal processing to the received signal at the signal processing CPU 51 and outputs signal including information of a property and a register code of the received signal by means of the transmitting system. The property of the signal includes information indicating that the received signal transmitted from the vehicle exterior transmitting antenna 74. At the vehicle side, a tuner 71 receives an electric wave including the signal transmitted from the portable device 5, and the system ECU 1 confirms the property and the register code so that it is recognized that the portable device 5, which serves as a electric key and is registered to the vehicle, approaches the vehicle (Step 11).

After the system ECU 1 recognizes the portable device 5 approaching the vehicle, the smart entry system moves to an operation detecting mode. In the operation detecting mode, the system ECU 1 observes, during a predetermined time period, whether or not the first detecting portion 31 detects the user's door handle operation to unlock the vehicle door (Step 12) and the user's door handle operation is transmitted to the system ECU 1. If the user's door handle operation is not transmitted from the first detecting portion 31 to the system ECU 1 (Step 12: No), the process is finished. If the user's door handle operation is transmitted from the first detecting portion 31 to the system ECU 1 during the predetermined time period (Step 12: Yes), the system ECU 1 proceeds to Step 13. In Step 13, it is confirmed whether or not the vehicle door 6 is locked. If the system ECU 1 detects that the vehicle door 6 (Step 13 No) is locked, the process goes to Step 15. In Step 15, the system ECU 1 instructs the door ECU 61 of the vehicle door 6 to unlock the vehicle door 6. Specifically, the lock actuator 64 is actuated so as to unlock the vehicle door 6. After the vehicle door 6 is unlocked, the smart entry system moves to a door opening detecting mode and executes a vehicle door opening process as described later. On the other hand, if it is detected that all the vehicle doors 6 are unlocked (Step 13: Yes), the process directory proceeds to the door opening detecting mode without executing the vehicle door unlocking process. In Step 14, the vehicle door opening process is executed.

(Door Opening Process)

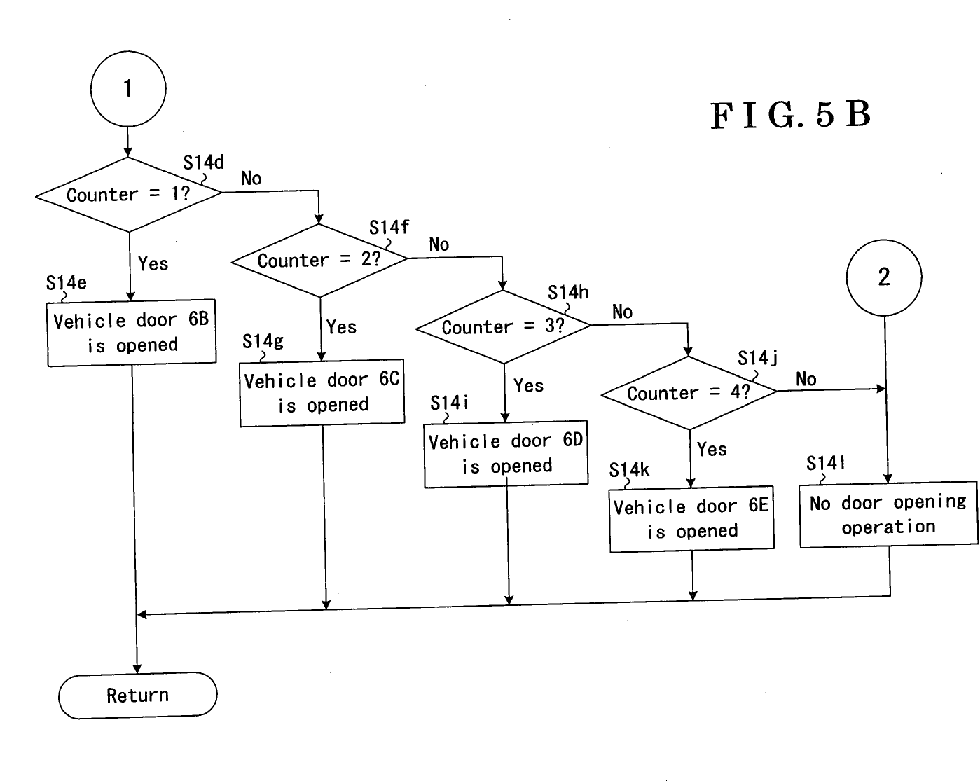

A vehicle door opening process will be explained on the basis of FIG. 4, FIG. 5A and FIG. 5B. In the door opening detecting mode, the system ECU 1 controls the sensor driver of the vehicle exterior driver 9 to observe whether or not a signal is sent from the second detecting portion 32 while the first detecting portion 31 have been detecting the user physically contacting the first detecting portion 31 (Step 14a). If the user's door handle operation detected by the second detecting portion 32 is inputted into the system ECU 1 (Step 14a), the process goes to Step 14b. In Step 14b, 1 is added to a counter, and the process goes to Step 14c. In Step 14c, if a predetermined time has passed since the first user's door handle operation detected by the second detecting portion 32 has been inputted into the ECU 1 while the first detecting portion 31 has been detecting the user physically contacting the first detecting portion 31 (Step 14c: Yes), the system ECU 1 instructs one of the door ECUs 61, which corresponds to the counter number, to actuate the door actuator 62, and one of the vehicle doors 6, which corresponds to the counter number, is opened (Step 14d through Step 14k). On the other hand, if a predetermined time has not passed since the first user's door handle operation detected by the second detecting portion 32 has been inputted into the ECU 1 while the first detecting portion 31 has been detecting the user physically contacting the first detecting portion 31, Step 14a through Step 14c are repeated, and every time the signal from the second detecting portion 32 is detected, 1 is added to the counter. If there is no vehicle door 6, which corresponds to the counter number, the vehicle door opening process is not executed (Step 14l).

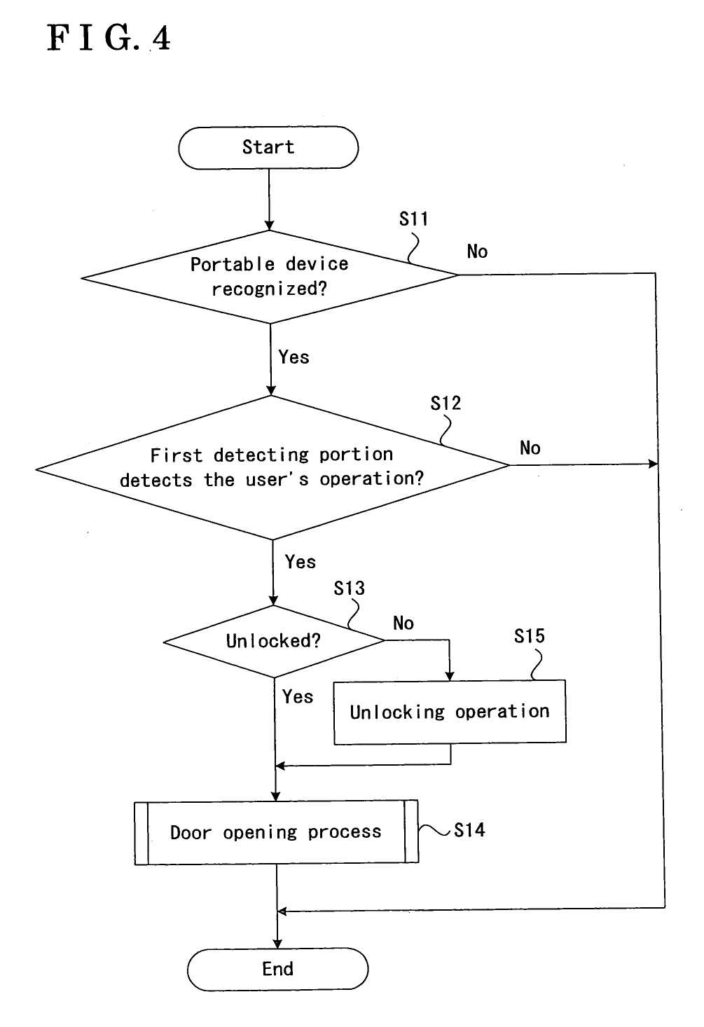

In accordance with FIGS. 1, 3 and 5, as an example of the vehicle door opening process by which one of vehicle doors 6B, 6C, 6D and 6E is opened by operating the door handle 2 provided at a vehicle door 6A of the driver's seat will be explained. When the vehicle door 6 is unlocked, and the user grips the door handle 2 provided at the vehicle door 6A, the first detecting portion 31A detects the user contacting the first detecting portion 13A, and the process moves to the door opening detecting mode. If the predetermined time has passed since the user's door handle operation detected by the second detecting portion 32 has been inputted into the ECU 1 while the first detecting portion 31A has been detecting the user physically contacting the first detecting portion 31A, the system ECU 1 instructs the door ECU 61B provided at the vehicle door 6B, which is provided at, for example, the rear seat of the passenger's seat, to actuate the door actuator 62B, and then the vehicle door 6B is opened (Step 14e). If the user touches the second detecting portion 32A twice, while the user has been gripping the door handle 2 and before the predetermined time period has passed, the vehicle door 6C at the passenger's seat is opened (Step 14g). If the user touches the second detecting portion 21A three times, while the user has been gripping the door handle 2 and before the predetermined time period has passed, the vehicle door 6D, which is provided at the rear seat of the driver's seat side, is opened (Step 14i). The user touches the second detecting portion 21A four times, while the user has been gripping the door handle 2 and before the predetermined time period has passed, the vehicle door 6E, which is provided at the rear luggage space, is opened (Step 14k). Thus, while the first detecting portion 31 has been detected the user physically contacting the first detecting portion 31, the input means 3 operates the selected vehicle door 6 depending on the number of touches detected by the second detecting portion 32.

As mentioned above, because the vehicle doors 6B through 6E are opened by operating the door handle 2 provided at the vehicle door 6A at the driver's seat side, there is no need for the driver to move to the passenger's door to open it for the passenger. The user stays at the driver's door side and operates the vehicle door 6C to open the doors from there.

The selected vehicle door 6 is opened depending on the number of times the user contacts the second detecting portion 32 or type of operation by the user detected by the second detecting portion 32, the user can open the selected vehicle door 6 by changing the number of times he/she contacts the second detecting portion 32 or changing the types of the door handle operation to open the vehicle door. In this configuration, because there is no need to provide a detecting portion to each of the vehicle doors 6, the number of parts assembled to the vehicle door can be reduced, as a result, a configuration of the vehicle door opening/closing device for opening and closing a selected vehicle door 6 can be downsized.

Further, according to the known vehicle door opening/closing device, when the user cannot find the remote control, the vehicle door 6 is not opened smoothly. According to the vehicle door opening/closing device of this embodiment according to the present invention, because the first detecting portion 31 and the second detecting portion 32 are provided at the door handle 2, which are provided at the vehicle door, there is no need to operate a controlling member such as a remote controller as described in the prior art, as a result, the selected vehicle door 6 can be opened smoothly.

In the above mentioned embodiment, the vehicle doors 6B through 6E are automatically opened, however, the number of the vehicle doors to be automatically opened may be changed to any number. The value of the counter may be set according to the number of the vehicle doors 6 to be automatically opened or the type of the user's door handle operation to open the vehicle door may be set according to the number of the vehicle door 6. Further, if there is no vehicle door 6 that corresponds to the counter value, the user may be notified by using a buzzer lump or the like in order to let them know that the vehicle door opening process is not executed. Further, in the embodiment, one counter value (one type of the user's door handle operation) corresponds to one vehicle door 6, however, one counter value (one type of the user's door handle operation) may correspond to plural vehicle doors 6.

In this embodiment, the vehicle doors 6B through 6E are opened by operating the door handle 2 of the vehicle door 6A, which is provided at the driver's seat, however, the door handle 2 by which the user's door handle operation is executed may be provided at the other vehicle door 6. Further, in the embodiment, the signal detected by the second detecting portion 32 is set on the basis of the number of contacts to the second detecting portion 32 by the user, however, this configuration may be changed. For example, the signal detected by the second detecting portion 32 may be set on the basis of a time period during which the user has touched the second detecting portion 23.

(Locking Process)

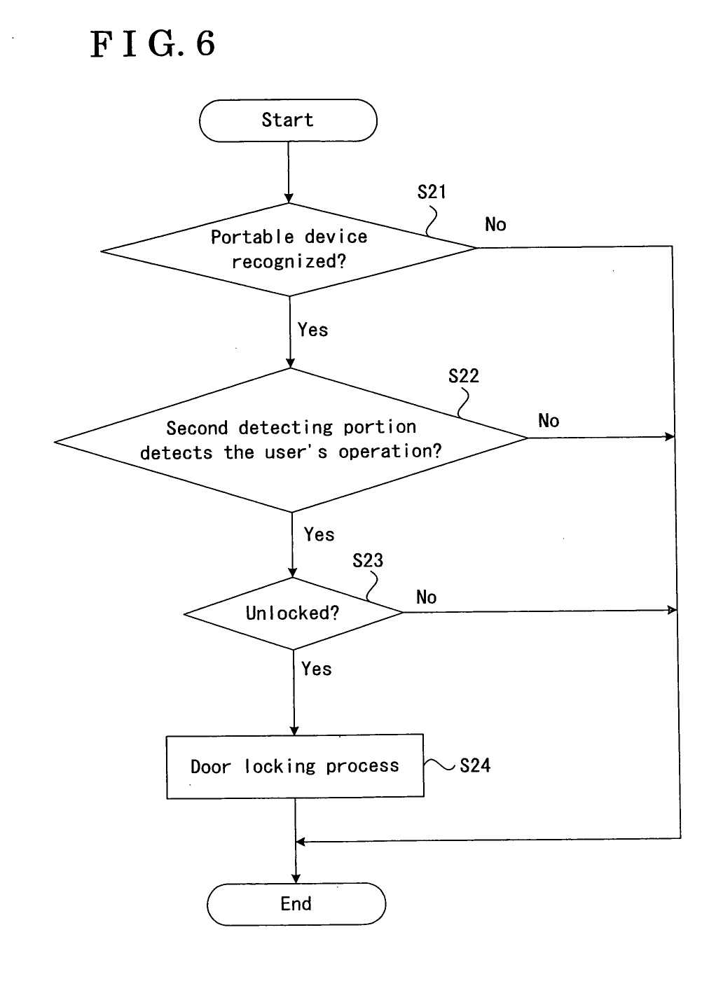

FIG. 6 illustrates a flow chart indicating a vehicle door locking process related to the embodiment of the present invention. The vehicle door locking process executed after the user gets out of the vehicle will be explained in accordance with the FIG. 6. When the user exists within the vehicle interior 7, it is considered that the portable device 5 (electric key) possessed by the user also exists within the vehicle interior 7. The portable device 5 receives the request signal, which is modulated and amplified at the vehicle interior driver 72 provided within the vehicle interior 7, and outputted from the vehicle interior transmitting antenna 73. The portable device 5 executes the signal processing to the received signal at the signal processing CPU 51 and outputs information including a property and a register code of the received signal by means of the transmitting system 53. An electric wave of the signal outputted from the portable device 5 is received by the tuner 71, and the system ECU 1 recognizes the information including a property and a register code of the received signal so that the system ECU 1 recognizes that the portable device 5 exists within the vehicle interior 7.

In this circumstance, when the user possessing the portable device 5 gets out of the vehicle, and the vehicle door 6 is closed; the above mentioned signal communication is interrupted. At this point, the system ECU 1 recognizes that the portable device 5 exists outside of the vehicle interior 7 (Step 21). In Step 21, it may be confirmed that a communication with a signal output from the vehicle exterior transmitting antenna 74 is established.

When the system ECU 1 recognizes that the user gets out of the vehicle, and the vehicle door 6 is closed; the smart entry system proceeds to a locking detecting mode. In the locking detecting mode, the system ECU 1 controls a sensor driver (not shown) of the vehicle exterior driver 9 and observes whether or not the user's door handle operation to lock the vehicle door is detected by the second detecting portion 32 during a predetermined time period (Step 22). If a predetermined time has passed and the user's door handle operation detected by the second detecting portion 32 has not been inputted into the ECU 1 (Step 22: No), the process is finished. If the user's door handle operation to lock the vehicle door has been inputted into the ECU 1 before the predetermined time has passed (Step 22 Yes), the process goes to Step 23. In Step 23, the system ECU 1 recognizes whether or not the vehicle door 6 is unlocked. If the system ECU 1 detects that all of the vehicle doors 6 are locked, the process is finished (Step 23: No), and if the system ECU 1 detects that at least one of the vehicle doors 6 is locked (Step 23: Yes), the system ECU 1 instructs the lock ECU 63 to actuate the lock actuator 64, as a result, the vehicle door 6 is locked (Step 24).

As mentioned above, when the present invention is applied to the smart entry system, because the vehicle door is opened by a combination of the first detecting portion 31 used for the vehicle door unlocking operation and the second detecting portion 32 used for the vehicle door locking operation; there is no need to provide an additional detecting device to execute the vehicle door opening operation. Thus, the number of parts assembled to the vehicle door can be reduced, and a configuration of the vehicle door opening/closing device for opening and closing a selected vehicle door 6 can be downsized.

In the above embodiment, the present invention is applied to the smart entry system, however, the smart entry system is not an essential element for the present invention. The vehicle door opening/closing device may be configured in a manner where the first detecting portion 31 and the second detecting portion 32 can execute the vehicle door opening process of the other selected vehicle door. Further, according to the above embodiment, the input means 3 includes the first detecting portion 31 and the second detecting portion 32, however, the configuration of the input means 3 is not limited to the embodiment. For example, the vehicle door 6 provided at the passenger's seat side may be opened when the user presses a mechanical switch provided at the door handle 2 of the vehicle door 6 at the driver's seat side. Thus, any configuration can be applied to the input means of the present invention as long as it is provided at the door handle 2 of the vehicle door 6, and the input means 3 detects the user's door handle operation to open the other selected vehicle door.

In the abovementioned configuration, because the input means provided at the door handle inputs the user's door handle operation to open one of the doors to which the door handle is not provided, when the user intends to open the door to which the door handle is not provided, the user does not need to move to the side of the door to which the door handle is not provided in order to open it. Further, because the input means is provided at the door handle that is one member of the vehicle door, the vehicle door is opened without operating a known remote controller or the like. Thus, the vehicle door can be opened rapidly.

In abovementioned configuration, the input means includes the first detecting portion and the second detecting portion detecting the user's physical contact to the input means, and while the first detecting portion has been detecting the contact, the second detecting portion inputs the user's door handle operation to open the vehicle door.

Thus, the vehicle door is opened on the basis of inputted results at both of the first detecting portion and the second detecting portion. In this configuration, even when the user, who does not intend to open the door, touches the door handle accidentally, because only one of the detecting portions detects this operation, the other door to which the door handle is not provided is not opened. Thus, accidental vehicle door openings can be reduced.

In abovementioned configuration, when the portable device possessed by the user exists within a predetermined range relative to the vehicle, the vehicle door opening/closing device recognizes the existence of the portable device. When the first detecting portion detects the user's door handle operation to unlock the vehicle door while the portable device has been recognized, the control means executes the vehicle door unlocking process, and when the user's door handle operation to unlock the vehicle door is detected by the first detecting portion and the user's door handle operation to open the vehicle door is detected by the second detecting portion, the control means executes the vehicle door opening process.

In this configuration, plural types of the user's door handle operation to open the vehicle door can be detected by the second detecting portion, and the control means opens a selected vehicle door in accordance with the type of the user's door handle operation. Thus, the user can open the selected vehicle door by changing the type of the door handle operation detected by the second detecting portion. Thus, there is no need to provide a detecting portion to all of the vehicle doors, as a result, the number of parts assembled to the vehicle door can be reduced, and a configuration of the vehicle door opening/closing device for opening and closing a selected vehicle door can be downsized.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A vehicle door opening/closing device comprising:
a door handle provided at the exterior of a vehicle door and by which the vehicle door is opened and closed;
control means executing a vehicle door opening process for the vehicle door on the basis of a user's door handle operation to open the vehicle door;
input means provided at the door handle and inputting the user's door handle operation to open the vehicle door, wherein
on the basis of the user's door handle operation to open the vehicle door, the control means executes the vehicle door opening process for one of vehicle doors, to which the door handle is not provided.

2. The vehicle door opening/closing device according to claim 1, wherein the input means includes a first detecting portion and a second detecting portion, each of which detects a user's physical contact, and the second detecting portion detects the user's door handle operation to open the door while the first detecting portion has been detecting the user's physical contact.

3. The vehicle door opening/closing device according to claim 2 further including a portable device possessed by the user and recognized by the control means when the portable device exists within a predetermined range relative to the vehicle, and when a user's door handle operation to unlock the door is detected by the first detecting portion while the portable device has been recognized, the control means executes a vehicle door unlocking process, and when the user's door handle operation to unlock the door is detected by the first detecting portion and the user's door handle operation to open the vehicle door is detected by the second detecting portion, the control means executes the vehicle door opening process.

4. The vehicle door opening/closing device according to claim 2, wherein plural types of the user's door handle operation to open the vehicle door are detected and inputted by the second detecting portion, and the control means executes the vehicle door opening process for the one of the vehicle doors, to which the door handle is not provided, is opened depending on the type of the user's door handle operation to open the vehicle door.

5. The vehicle door opening/closing device according to claim 3, wherein plural types of the user's door handle operation to open the vehicle door are detected and inputted by the second detecting portion, and the control means executes the vehicle door opening process for the one of the vehicle doors, to which the door handle is not provided, is opened depending on the type of the user's door handle operation to open the vehicle door.
